(19) United States
(12) Patent Application Publication
(10) Pub. No.: US 2023/0417100 A1
(43) Pub. Date: Dec. 28, 2023

(54) FENESTRATION APPARATUS AND RELATED METHODS

(71) Applicant: CORNING INCORPORATED, CORNING, NY (US)

(72) Inventors: Anthony Robert Board, Breesport, NY (US); James Gregory Couillard, Ithaca, NY (US)

(21) Appl. No.: 18/036,786

(22) PCT Filed: Nov. 19, 2021
(86) PCT No.: PCT/US2021/060068

§ 371 Date: May 12, 2023

Related U.S. Application Data
(60) Provisional application No. 63/116,369, filed on Nov. 20, 2020.

(51) Int. Cl. E06B 3/28; B32B 17/10; B32B 3/06; B32B 33/00

(52) U.S. Cl. CPC E06B 3/28; B32B 17/10036; B32B 3/06; B32B 17/10779; B32B 17/1077; B32B 17/10651; B32B 17/10137; B32B 33/00; B32B 2307/102; B32B 2307/7376

(57) ABSTRACT

In various embodiments of the present disclosure, a fenestration apparatus is provided, comprising: a laminate having a thickness of not greater than 3 mm; a frame, configured perimetrically around a corresponding perimetrical edge of the glass pane; a seal, configured between the frame and the glass pane; and an attachment member configured to the frame, wherein the attachment member is configured to be removably fixable to an existing window wherein the attachment member is configured to define a gap between the frame, the at least one glass pane, and the existing window.

### CROSS-REFERENCE TO RELATED APPLICATIONS

This application claims the benefit of priority under 35 U.S.C. § 119 of U.S. Provisional Application No. 62/116,369 filed Nov. 20, 2020, the content of which is incorporated herein by reference in its entirety.

### FIELD OF THE INVENTION

Broadly, the present disclosure is directed towards embodiments of a fenestration apparatus (e.g. sometimes called a secondary glazing system) incorporating thin glass laminate(s). More specifically, the fenestration apparatuses are configured for retrofit installation onto an existing fenestration assembly (e.g. window, door, or other fenestration opening(s) and/or architectural glazing(s)). More specifically, the present disclosure is directed towards various embodiments of an apparatus, and related methods of use, for a fenestration apparatus having at least one thin glass laminate, in accordance with the present disclosure.

### BACKGROUND

Many older buildings were built with single pane windows, which due to relatively poor insulation value lead to high heating and air conditioning costs and do not provide optimal inhabitant comfort. Retrofitting to install double or triple pane windows would require significant expense and disruption. Such a retrofit may not even be possible due to historic or landmark designation of the building, or if the building framework is not capable of handling the additional glass weight. The older windows of older buildings with have limited performance, including limited thermal insulation, limited acoustic dampening, and an inability to filter undesired wavelengths of light (e.g. UV or infrared). Improved performance is desired.

### SUMMARY

The present disclosure is a thin glass laminate in a frame which can be installed within or surrounding an existing single pane window. This secondary glazing system (SGS) is easy to install and can be easily removed for window cleaning, which is important for commercial high-rise buildings. By adding a second air cavity (e.g. or third air cavity, in instances of a dual-pane supplemental glazing system) the fenestration apparatuses of the present disclosure significantly improve energy performance of the single-pane windows. The present disclosure uses a thin glass laminate, with almost half the weight of a single glass pane (e.g. when compared to conventional architectural glass thicknesses). The laminate can also be designed to qualify as safety glazing under ANSI Z97.1 or EN 12600 standards, thereby providing additional safety and security to the inhabitants.

In some embodiments, the apparatus is an architectural product.

In one aspect, a fenestration apparatus, is provided, comprising: at least one glass pane comprising a laminate, wherein the laminate has a thickness of not greater than 3 mm, a frame, configured perimetrically around a corresponding perimetrical edge of the glass pane; a seal, configured between the frame and the glass pane; and an attachment member configured to the frame, wherein the attachment member is configured to be removably fixable to an existing window wherein the attachment member is configured to define a sealed gap between the frame, the at least one glass pane, and the existing window.

In some embodiments, the attachment member comprises a compression member (removably attached via compression fit). In some embodiments, the attachment member comprises a mechanical attachment member, comprising: a lock member, a latch member, a screw, and/or combinations thereof.

In some embodiments, the laminate comprises a first glass layer a second glass layer, and an interlayer configured between the first glass layer and the second glass layer to attach the first glass layer to the second glass layer.

In some embodiments, the attachment member comprises a compression fitting.

In some embodiments, the attachment member comprises an expandable gasket and a release member.

In some embodiments, the attachment member comprises a mechanical attachment device, wherein the mechanical attachment device is configured to cooperate in mating engagement with a corresponding fenestration assembly component. (mechanical fasteners, hook and latch, screws, etc.). In various embodiments, the fenestration apparatus is configured to removably attach to an existing fenestration assembly, in dimensions to cover the existing glazing, where the fenestration assembly is, as non-limiting examples: a window, a door, a skylight, a curtain wall, and/or combinations thereof.

In some embodiments, wherein the frame is configured with a base, configured to retain on an existing window frame and/or alongside an existing window frame assembly.

In some embodiments, wherein the frame is configured with at least two upward extensions along the perimetrical edge of the glass laminate, such that the first extension is configured alongside the first glass layer and the second extension is configured alongside the second glass layer.

In some embodiments, wherein the existing window comprises an adjacent perimetrical ledge/extension.

In some embodiments, wherein the first glass layer comprises a thickness of not greater than 1 mm.

In some embodiments, wherein the second glass layer comprises a thickness of not greater than 1 mm.

In some embodiments, wherein the interlayer comprises a thickness of not greater than 2.3 mm.

In some embodiments, the laminate thickness range is at least 0.5 mm to not greater than 2.5 mm. In some embodiments, the laminate thickness range is at least 0.75 mm to not greater than 2.5 mm. In some embodiments, the laminate thickness range is at least 0.75 mm to not greater than 2 mm. In some embodiments, the laminate thickness range is at least 1 mm to not greater than 2.75 mm.

In some embodiments, the laminate thickness is not greater not greater than 3 mm; not greater than 2.5 mm; not greater than 2 mm; or not greater than 1.5 mm. In some embodiments, the laminate thickness is at least 2.9 mm; at least 2.5 mm; at least 2.7 mm; at least 1.5 mm; at least 1.3 mm; or at least 1 mm.

In some embodiments, the interlayer layer thickness is at least 0.3 mm to not greater than 2.4 mm. In some embodiments, the interlayer layer thickness is at least 0.5 mm to not greater than 2 mm.

In some embodiments, the interlayer layer thickness is at least 0.75 mm to not greater than 2 mm. In some embodiments, the interlayer layer thickness is at least 0.5 mm to not greater than 1 mm. In some embodiments, the interlayer layer thickness is at least 0.75 mm to not greater than 1.5 mm. In one embodiment, the first laminate comprises a first glass sheet having a thickness of 0.5 mm, a second glass sheet having a thickness of 0.5 mm, and an interlayer thickness of 0.3 mm. In one embodiment, the laminate comprises a first glass layer having a thickness of 0.5 mm, a second glass layer having a thickness of 0.5 mm, and an interlayer thickness of 0.6 mm.

In some embodiments, wherein the interlayer comprises a polymer.

In some embodiments, wherein the interlayer comprises: a polymer, a polyester, an ionomer, and/or combinations thereof.

In some embodiments, the interlayer comprises: the interlayer comprises: a polyvinyl butyral (PVB), a thermoplastic polyurethane (TPU), a PET, and combinations thereof.

In some embodiments, the laminate comprises a coating on at least one of: a first major surface of the first glass layer, a second major surface of the second glass layer, and both the first major surface of the first glass layer and the second major surface of the second glass layer.

As some non-limiting examples, the coating includes: a low emissivity coating, an anti-reflective coating; a tint coating; an easy clean coating; or an anti-bird strike coating. In some embodiments, the coating is a partial coating. In some embodiments, the coating is a full coating. In some embodiments (e.g. anti-bird strike coating), the coating is patterned along discrete portions of the surface.

In some embodiments, the laminate comprises a low emissivity coating on at least one of: a first major surface of the first glass layer, a second major surface of the second glass layer, and both the first major surface of the first glass layer and the second major surface of the second glass layer.

For example, the low emissivity coating can be comprised of a combination of metals and oxides, including non-limiting examples of silicon nitride, metallic silver, silicon dioxide, tin oxide, zirconium oxide, and/or combinations thereof, to name a few.

In some embodiments, the interlayer is an acoustic dampening polymer configured for noise reduction.

In some embodiments, the fenestration apparatus is a removable secondary glazing assembly.

In some embodiments, the interlayer is a tinted polymer configured for light absorption. In various embodiments, the tinted polymer interlayer is configurable to absorb at least some UV light, infra-red light, visible light, and/or combinations thereof.

In some embodiments, the fenestration apparatus passes a safety test as set out in ANSI Z97.1 or EN 12600 standard, when measured in accordance with the standard.

In some embodiments, at least one of the first glass layer and the second glass layer is a thermally or chemically strengthened glass.

In some embodiments, the fenestration apparatus further comprises a second pane disposed in spaced relation from the first pane.

In some embodiments, the frame is configured with a sealing member between the first pane and the second pane.

In some embodiments, the first pane, the second pane, and the sealing member cooperate to define an inner gap therebetween.

In some embodiments, an insulating gas is retained within the inner gap.

In one embodiment, the defined gap is filled with non-reactive gas (e.g. configured to promote better thermal performance). Non-limiting examples of gas in the first or second defined gap include: inert gas (e.g. Kr, Ar), air, and mixtures thereof, to name a few. In some embodiments, the defined gap between the first laminate and the second laminate are configured with an internal pressure in vacuum.

In one embodiment, the spacer is metal, plastic, polymeric, and/or a combination thereof.

In one embodiment, the spacer includes a desiccant, configured therein. For example, the desiccant is configured to reduce, prevent and/or eliminate presence of moisture (e.g. fog) in the first defined gap and/or second defined gap.

In some embodiments, the second pane is a laminate of thickness less than 3 mm.

In some embodiments, the second laminate comprises: a first glass layer having a thickness of not greater than 0.5 mm; a second glass layer having a thickness of not greater than 0.5 mm; and an interlayer configured between the first and second layer, wherein the interlayer comprises PVB.

In some embodiments, the first layer is an inorganic glass.

In some embodiments, the first layer is an alkaline earth boro-aluminosilicate glass.

In some embodiments, the second layer is an inorganic glass.

In some embodiments, the second layer is an alkaline earth boro-aluminosilicate glass.

In one embodiment, the first sheet and the second sheet or a laminate (first laminate and/or second laminate) are composed of the same glass compositions. In one embodiment, the first sheet and the second sheet of a laminate (first laminate and/or second laminate) are composed of different types of glass (and/or different glass compositions).

In some embodiments, the first glass pane has a thickness of 0.3 mm to not greater than 1 mm.

In some embodiments, the second glass layer has a thickness of 0.3 mm to not greater than 1 mm.

In some embodiments, the frame is configured with thermal insulating material.

In another aspect, a secondary glazing apparatus is provided, comprising: a first glass pane, the first glass pane comprising a laminate, wherein the laminate has a thickness of not greater than 3 mm, [e.g. wherein the laminate comprises a first glass layer a second glass layer, and an interlayer configured between the first glass layer and the second glass layer to attach the first glass layer to the second glass layer,] a second glass pane, the second glass pane comprising a laminate, wherein the laminate has a thickness of not greater than 3 mm, [wherein the laminate comprises a first glass layer a second glass layer, and an interlayer configured between the first glass layer and the second glass layer to attach the first glass layer to the second glass layer;] a frame, configured perimetrically around a corresponding perimetrical edge of the first glass pane and the second glass pane; a glass-to-frame seal, configured between the frame, the first glass pane, and the second glass pane, wherein via the glass-to-frame seal, the first glass pane, the second glass pane, and an inner edge of the frame, a sealed gap is defined; and an attachment member configured to the frame, wherein the attachment member comprises a removable frame-to-fenestration assembly (existing frame or wall) seal, wherein the attachment member is configured to define a sealed gap between the frame, the glass-to-frame seal, at least one of the first glass pane and the second glass pane, and the fenestration assembly.

In another aspect, a method is provided, comprising: configuring a secondary glazing system along an existing fenestration assembly comprising an existing window and an existing frame; actuating an attachment member on the secondary glazing system; and securing the secondary glazing system over the existing window via a removable sealing engagement from the attachment member, thereby providing a retrofit window assembly having a sealed gap between the secondary glazing system and the existing window, wherein the retrofit window assembly is configured with improved performance as compared to the existing fenestration assembly.

In some embodiments, the retrofit window assembly is configured with acoustic dampening; increased insulation, tailored light filtering, safety glazing performance when measured in accordance with ANSI Z97.1 or EN 12600 standards, and combinations thereof.

In some embodiments, the securing step further comprises positioning the frame and at least one glass pane within the existing frame, such that the weight of the secondary glazing system is retained by the existing window frame.

In some embodiments, the sealing engagement further comprises positioning the secondary glazing system alongside the existing frame, such that the weight of the secondary glazing system is retained by the attachment member to the attachment locations along the existing window frame.

In some embodiments, the fenestration apparatus is configured for improved acoustic performance, as measured by the sound transmission class (STC) of ASTM E413 or outdoor-indoor transmission class (OITC) of ASTM E1332.

In some embodiments, the fenestration apparatus is configured with an improved optical clarity. In some embodiments, the fenestration apparatus is configured with lightweight design. In some embodiments, the fenestration apparatus is configured with improved scratch resistance.

In some embodiments, the fenestration apparatus is configured for removable attachment, to enable cleaning of the panels, seasonal management, and/or ease in installation with reduced breakage.

Non-limiting examples of some additional improved fenestration apparatus performance criterion (as compared to the existing fenestration assembly) include at least one of: acoustic dampening (e.g. improved/reduced sound transmittance through the fenestration assembly); safety performance (e.g. in compliance with safety rating or improved/reduced weight with thin center pane and in compliance with safety rating); improved/reduced solar heat gain coefficient; improved dimensions (e.g. reduced weight and/or reduced or maintained cross-sectional thickness); emissivity (e.g. improved/reduced emissivity with application or one or more low emissivity coatings); insulation (e.g. improved/reduced thermal transfer (hot or cold) from one end of the fenestration assembly to the other end, through the cross-sectional width); light transmittance (improved/reduced light transmittance and/or improved filtering of one or more types of light); modular drop-in configuration (e.g. present embodiment having same dimensional configuration as existing window, with minimal need for window mounting re-work in instances of retrofitting); and/or combinations thereof.

In some embodiments, solar heat gain coefficient is quantified and/or measured in accordance with ANSI/NFRC 200-2017_E0A1 Procedure for Determining Fenestration Product Solar Heat Gain Coefficient and Visible Transmittance at Normal Incidence. In some embodiments, thermal insulation (U-value) is quantified and/or measured in accordance with ASTM E1423-14 Standard Practice for Determining Steady State Thermal Transmittance of Fenestration Systems and/or ANSI/NFRC 100-2017_E0A2 Procedure for Determining Fenestration Product U-factors.

In some embodiments, the fenestration apparatus comprises a laminate configured to pass safety glazing standards in accordance with at least one of: ANSI Z97.1 or EN 12600 standards, thereby providing additional safety and security to the inhabitants.

In some embodiments, low emissivity coatings (e.g. silver-containing low-e coatings), in conjunction with a sealed gas cavity, are utilized to provide/promote improved thermal properties.

The use of an SGS provides improvements in energy performance (and therefore cost), acoustics, and occupant comfort over existing single pane windows. The present disclosure provides light weight retrofit options, and hence ease of installation and removal. This in turn leads to lower initial installation costs and lower maintenance costs. The lower weight is compatible with a wider range of existing building structures, which may not be able to large loads of thick glass.

Additional features and advantages will be set forth in the detailed description which follows and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the disclosure as it is claimed.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following aspects.

### BRIEF DESCRIPTION OF THE DRAWINGS

These and other features, aspects and advantages of the present disclosure are better understood when the following detailed description of the disclosure is read with reference to the accompanying drawings, in which:

FIG. 1A depicts an embodiment of the fenestration apparatus of the present disclosure, illustrating a partial schematic view of a laminate retained in a frame, in accordance with one or more aspects of the present disclosure.

FIG. 1B depicts an embodiment of the fenestration apparatus of the present disclosure, illustrating a partial schematic view of a laminate retained in a frame with a coating configured on at least a portion of a major surface of the laminate (e.g. ‘outer surface of the first sheet’), in accordance with one or more aspects of the present disclosure.

FIG. 1C depicts an embodiment of the fenestration apparatus of the present disclosure, illustrating a partial schematic view of a laminate retained in a frame with a coating configured on at least a portion of a major surface of the laminate (e.g. ‘outer surface of the second sheet’), in accordance with one or more aspects of the present disclosure.

FIG. 1D depicts an embodiment of the fenestration apparatus of the present disclosure, illustrating a partial schematic view of a laminate retained in a frame with a coating configured on at least a portion of a major surface of the laminate (e.g. ‘outer surface of the first sheet’ and ‘outer surface of the second sheet’), in accordance with one or more aspects of the present disclosure.

FIGS. 2A-2D depict a fenestration apparatus configured similarly, with varying positions of the coating(s), in accordance with various embodiments of the present disclosure.

FIG. 2A depicts an embodiment of the fenestration apparatus of the present disclosure, illustrating a partial schematic view of a first laminate and second laminate retained in a frame and set apart/secured in the frame via a seal, in accordance with one or more aspects of the present disclosure.

FIG. 2B depicts an embodiment of the fenestration apparatus 100 of the present disclosure, illustrating a partial schematic view of a first laminate 110 and second laminate retained in a frame and set apart/secured in the frame via a seal retained in a frame with a coating configured on at least a portion of a major surface of the laminate (e.g. ‘outer surface of the second sheet of the first laminate’), in accordance with one or more aspects of the present disclosure.

FIG. 2C depicts an embodiment of the fenestration apparatus of the present disclosure, illustrating a partial schematic view of a first laminate and second laminate retained in a frame and set apart/secured in the frame via a seal retained in a frame with a coating configured on at least a portion of a major surface of the laminate (e.g. ‘outer surface of the second sheet of the second laminate’), in accordance with one or more aspects of the present disclosure.

FIG. 2D depicts an embodiment of the fenestration apparatus of the present disclosure, illustrating a partial schematic view of a first laminate and second laminate retained in a frame and set apart/secured in the frame via a seal retained in a frame with a coating configured on at least a portion of a major surface of the laminate (e.g. ‘outer surface of the first sheet of the first laminate’ and ‘outer surface of the second sheet of the second laminate’), in accordance with one or more aspects of the present disclosure.

FIG. 3, FIG. 4A, FIG. 4B, and FIG. 7A-7B each depict varying orientations of how one or more embodiments of the fenestration apparatus of the present disclosure are configured (e.g. retrofit engagement) with an existing fenestration assembly (e.g. existing window, existing door, or architectural glazing).

FIG. 3 depicts a schematic view of an embodiment of a fenestration apparatus configured as a secondary glazing system, where the fenestration apparatus is positioned over an existing window such that it sits within the enclosure of the existing window (within the window ledge/windowsill) and is configured to attach via an attachment member comprising a plurality of compressive engagement members with the existing window enclosure, in accordance with one or more aspects of the present disclosure.

FIG. 4A depicts a schematic view of an embodiment of a fenestration apparatus configured as a secondary glazing system, where the fenestration apparatus is positioned over an existing window such that it sits adjacent to the enclosure of the existing window (to thereby extend over/cover the existing window/glazing) and is configured to attach to the existing window frame via at least one attachment member configured as at least one mechanical attachment member, in accordance with one or more aspects of the present disclosure.

FIG. 4B depicts a schematic view of an embodiment of a fenestration apparatus configured as a secondary glazing system, where the fenestration apparatus is positioned over an existing window and existing frame such that it sits adjacent to the enclosure of the existing window (to thereby extend over/cover the existing window/glazing and the existing frame) and is configured to attach to the area adjacent to the existing window frame (e.g. wall surface) via at least one attachment member configured as at least one mechanical attachment member, in accordance with one or more aspects of the present disclosure.

FIG. 5A depicts a schematic view of an embodiment of a fenestration apparatus configured as a secondary glazing system, where the fenestration apparatus having a laminate retained in a frame, which is positioned over an existing window such that it sits within the enclosure of the existing window (within the window ledge/window sill) and is configured to attach via an attachment member comprising a plurality of compressive engagement members with the existing window enclosure, in accordance with one or more aspects of the present disclosure.

FIG. 5B depicts a schematic view of an embodiment of a fenestration apparatus configured as a secondary glazing system, where the fenestration apparatus having a first laminate and a second laminate retained in a frame with a spacer configured between the first laminate and second laminates, where the secondary glazing system is positioned over an existing window such that it sits within the enclosure of the existing window (within the window ledge/window sill) and is configured to attach via an attachment member comprising a plurality of compressive engagement members with the existing window enclosure, in accordance with one or more aspects of the present disclosure.

FIG. 6A depicts a schematic view of an embodiment of a fenestration apparatus configured as a secondary glazing system, where the fenestration apparatus having a laminate retained in a frame, which is positioned over an existing window such that it sits adjacent to the existing frame and is configured to attach via an attachment member comprising a mechanical attachment member to the existing frame, in accordance with one or more aspects of the present disclosure.

FIG. 6B depicts a schematic view of an embodiment of a fenestration apparatus configured as a secondary glazing system, where the fenestration apparatus having a first laminate and a second laminate retained in a frame with a spacer configured between the first laminate and second laminates, where the secondary glazing system is positioned over an existing window such that it sits adjacent to the existing frame and is configured to attach via an attachment member comprising a mechanical attachment member to the existing frame, in accordance with one or more aspects of the present disclosure.

FIG. 7A and FIG. 7B depict schematic views of an embodiment of a fenestration apparatus configured as a secondary glazing system, in accordance with one or more aspects of the present disclosure.

FIG. 7B depicts a schematic view of an embodiment of a fenestration apparatus configured as a secondary glazing system, where the fenestration apparatus having a first laminate and a second laminate retained in a frame (and with a spacer configured between the first laminate and the second laminate), where the secondary glazing system is configured to extend across an existing window, where the frame is configured to both (a) rest within an existing frame and be retained via an attachment member that comprises a compression member; and (b) extend adjacent to the existing frame, such that the frame extension is configured to mechanically attach to the existing frame, in accordance with one or more aspects of the present disclosure.

### DETAILED DESCRIPTION OF THE DRAWINGS

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

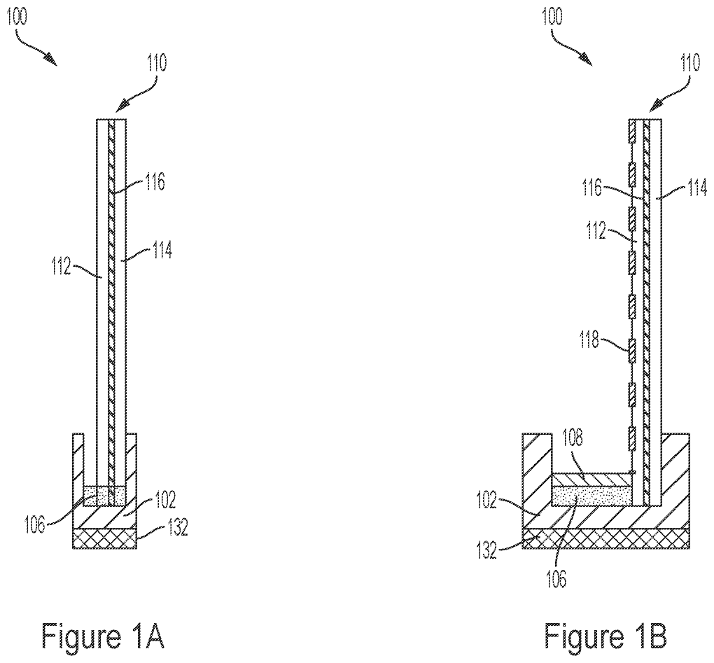

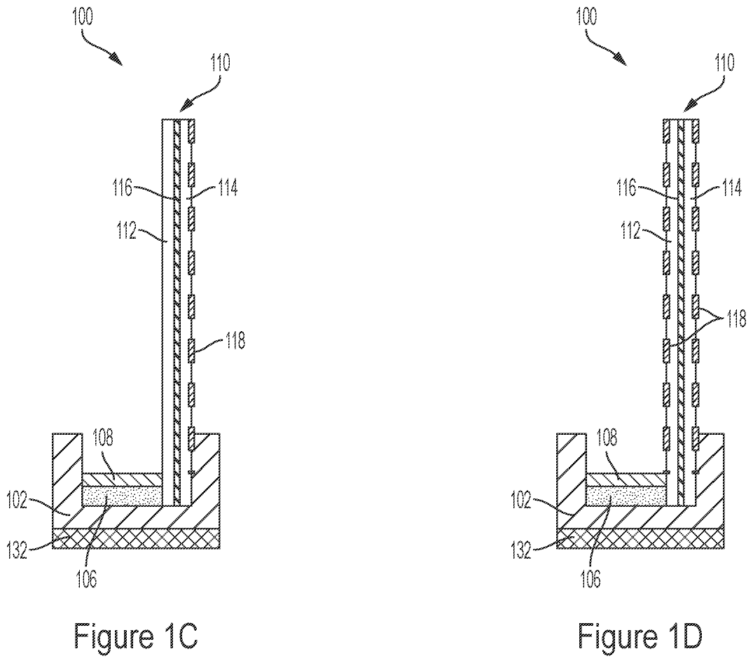

FIG. 1A depicts an embodiment of the fenestration apparatus 100 of the present disclosure, illustrating a partial schematic view of a laminate 110 retained in a frame 102, in accordance with one or more aspects of the present disclosure.

As shown in FIG. 1A, the fenestration apparatus 100 includes a laminate structure 110 comprising a first sheet 112 of the laminate structure, a second sheet 114 of the laminate structure, and an interlayer 116 positioned between the first sheet 112 and the second sheet 114. The laminate has a frame 102 configured to perimetrically surround an outer edge of the laminate 110, such that the frame 102 cooperates with seal 106 configured between the outer edge of the laminate 110 and the frame 102, to retain the laminate 110 therein. Also, the frame 102 has an attachment member 132 configured thereon, such that the fenestration apparatus 100 is configured to cooperate with an existing fenestration assembly 10 (e.g. existing window, existing door, or other architectural glazing) to provide removable attachment to the existing assembly 10 and provide tailored features and/or improvements to one or more attributes, and advantages to the existing fenestration structure 10 when used in conjunction with the fenestration apparatus 100 described herein.

FIG. 1B depicts an embodiment of the fenestration apparatus 100 of the present disclosure, illustrating a partial schematic view of a laminate 110 retained in a frame with a coating 118 configured on at least a portion of a major surface of the laminate 110 (e.g. ‘outer surface of the first sheet 112’), in accordance with one or more aspects of the present disclosure.

Referring to FIG. 1B, the laminate 110 includes a first sheet 112, a second sheet 114, and an interlayer 116 positioned between the first sheet 112 and second sheet 114 and configured to attach the first sheet 112 to the second sheet 114. The laminate 110 is configured with a seal 106 and a secondary seal 108 to retain the laminate 110 in the frame 102. The frame further includes an attachment member 132. Additionally, the laminate 110 is configured with a coating 118 on at least a portion of the outer surface (e.g. facing away from the interlayer 116) of the first layer 112.

FIG. 1C depicts an embodiment of the fenestration apparatus 100 of the present disclosure, illustrating a partial schematic view of a laminate 110 retained in a frame 102 with a coating 118 configured on at least a portion of a major surface of the laminate 110 (e.g. ‘outer surface of the second sheet 114’), in accordance with one or more aspects of the present disclosure.

FIG. 1C is similarly configured to FIG. 1B, except that the coating 118 is configured on at least a portion of the outer surface (e.g. positioned opposite the interlayer 116) of the second layer 114 of the laminate 110.

FIG. 1D depicts an embodiment of the fenestration apparatus 100 of the present disclosure, illustrating a partial schematic view of a laminate 110 retained in a frame 102 with a coating 118 configured on at least a portion of a major surface of the laminate 110 (e.g. ‘outer surface of the first sheet 112’ and ‘outer surface of the second sheet 122’), in accordance with one or more aspects of the present disclosure.

FIG. 1D is similarly configured to FIG. 1B and FIG. 1C, except that the coatings 118 are configured on both of the major surfaces/outer surfaces of the laminate 110, the first sheet 112 and the second sheet 114.

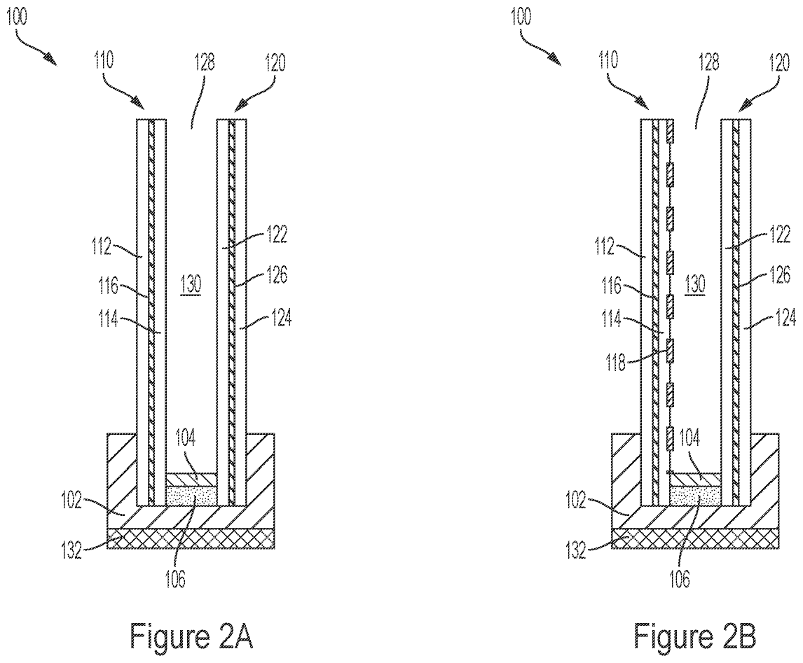

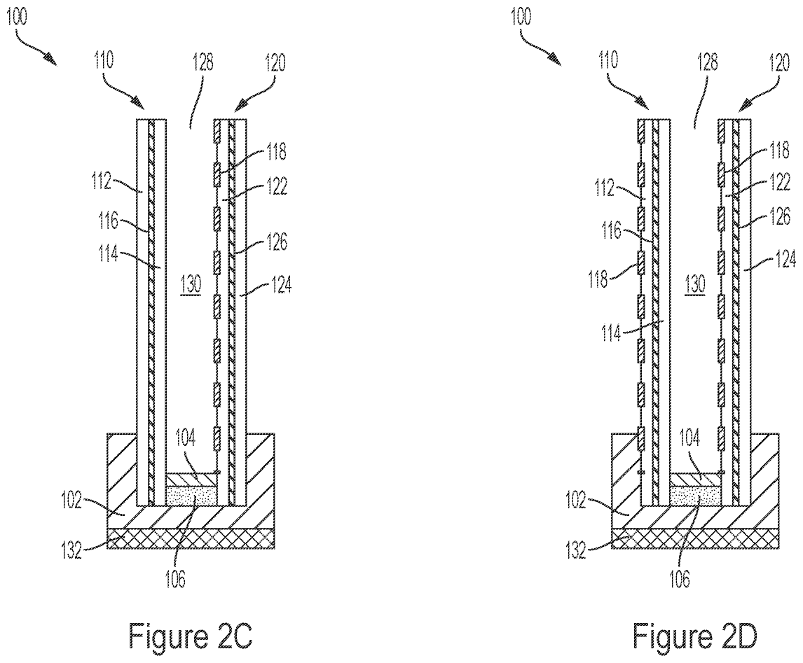

FIGS. 2A-2D depict a fenestration apparatus 100 configured similarly, with varying positions of the coating(s) 118, in accordance with various embodiments of the present disclosure.

FIG. 2A depicts an embodiment of the fenestration apparatus of the present disclosure, illustrating a partial schematic view of a first laminate 110 and second laminate 112 retained in a frame 102 and set apart/secured in the frame 102 via a seal 106, in accordance with one or more aspects of the present disclosure.

As shown in FIG. 2A, there are two laminates depicted, a first laminate 110 and a second laminate 120. The two laminates (110, 120) are spaced apart via a seal 106 and spacer 104, such that via the seal 106, and spacer 104, an interior gap 130 is defined between the first laminate 110 and the second laminate 120. A frame 102 is configured to retain the first laminate 110, the second laminate 120, and the seal (including seal 106 and spacer 104) in spaced arrangement. Further, the frame 102 is configured with an attachment member 132, configured to enable the fenestration apparatus 100 to removably attach/engage with an existing fenestration assembly 10 (e.g. existing window, existing door, or architectural glazing). The interior gap 130 is configured with a gas therein 128, which may have insulating attributes, acoustic attributes, among other improved parameters (as compared to the existing fenestration assembly without such fenestration apparatus removably attached thereto). The first laminate 110 includes a first sheet 112, a second sheet 114, and an interlayer 116 positioned between the first sheet 112 and the second sheet 114 and attaching the sheets together. The second laminate 120 includes a first sheet 122, a second sheet 124, and an interlayer 126 positioned between the first sheet 122 and the second sheet 124 and attaching the sheets together.

FIG. 2B depicts an embodiment of the fenestration apparatus 100 of the present disclosure, illustrating a partial schematic view of a first laminate 110 and second laminate 120 retained in a frame 102 and set apart/secured in the frame 102 via a seal 106 retained in a frame 102 with a coating 118 configured on at least a portion of a major surface of the laminate 110 (e.g. ‘outer surface of the second sheet 114 of the first laminate 110’), in accordance with one or more aspects of the present disclosure.

FIG. 2B is configured similarly to FIG. 2A, with the addition of a coating 118 positioned along at least a portion of the outer surface (e.g. facing away from the interlayer 116) of the second sheet 114 of the first laminate 110.

FIG. 2C depicts an embodiment of the fenestration apparatus 100 of the present disclosure, illustrating a partial schematic view of a first laminate 110 and second laminate 120 retained in a frame 102 and set apart/secured in the frame 102 via a seal 106 retained in a frame 102 with a coating 118 configured on at least a portion of a major surface of the laminate 120 (e.g. ‘outer surface of the second sheet 122 of the second laminate 120’), in accordance with one or more aspects of the present disclosure.

FIG. 2C is configured similarly to FIG. 2A, with the addition of a coating 118 positioned along at least a portion of the outer surface (e.g. facing away from the interlayer 126) of the second sheet 122 of the second laminate 120.

FIG. 2D depicts an embodiment of the fenestration apparatus 100 of the present disclosure, illustrating a partial schematic view of a first laminate 110 and second laminate 120 retained in a frame 102 and set apart/secured in the frame 102 via a seal 106 retained in a frame with a coating configured on at least a portion of a major surface of the laminate (e.g. ‘outer surface of the first sheet 112 of the first laminate 110’ and ‘outer surface of the second sheet 122 of the second laminate 120’), in accordance with one or more aspects of the present disclosure.

FIG. 2D is configured similarly to FIG. 2A, with the addition of two coatings 118 positioned along at least a portion two locations of the fenestration apparatus 100: (1) on at least apportion of the first layer 112 of the first laminate 110 and (2) on at least a portion of the second layer 122 of the second laminate 120.

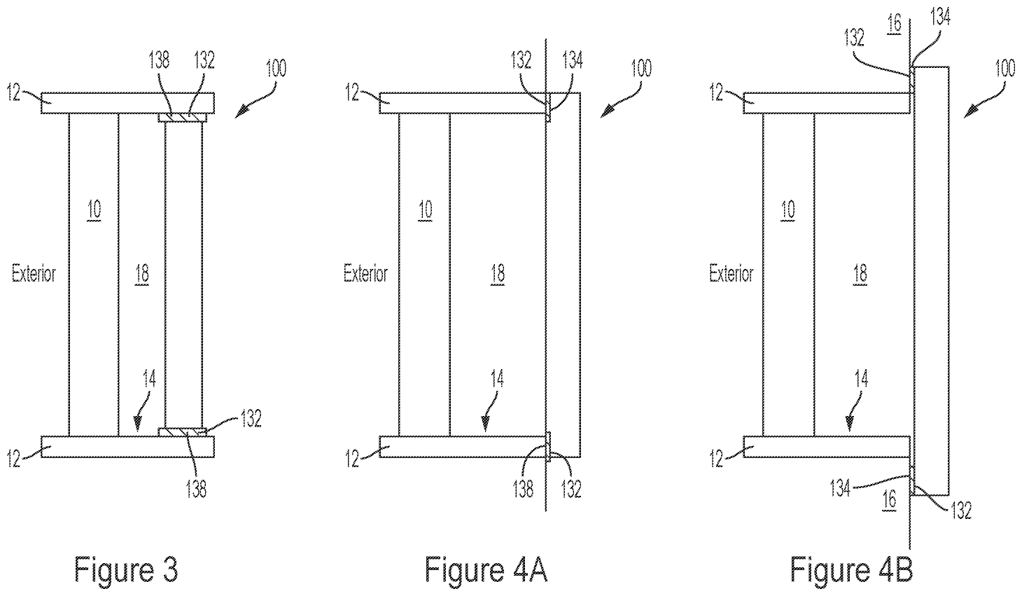

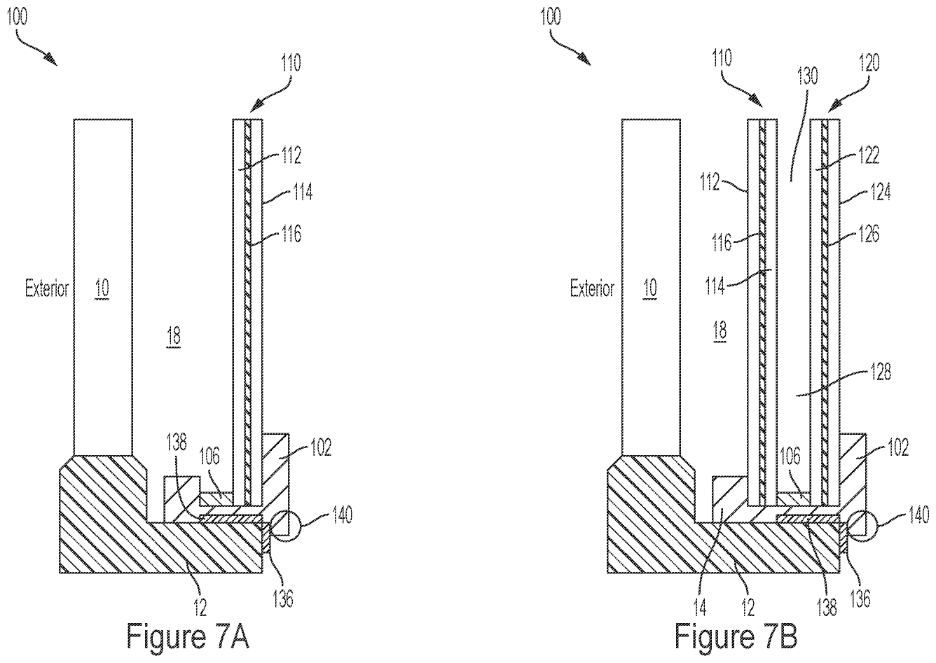

FIG. 3, FIG. 4A, FIG. 4B, and FIG. 7A-7B each depict varying orientations of how one or more embodiments of the fenestration apparatus 100 of the present disclosure are configured (e.g. retrofit engagement) with an existing fenestration assembly 10 (e.g. existing window, existing door, or architectural glazing).

FIG. 3 depicts a schematic view of an embodiment of a fenestration apparatus 100 configured as a secondary glazing system, where the fenestration apparatus 100 is positioned over an existing window 10 such that it sits within the enclosure of the existing window 10 (within the window ledge/windowsill 14) and is configured to attach via an attachment member 132 comprising a plurality of compression engagement members 138 with the existing window enclosure/windowsill 14, in accordance with one or more aspects of the present disclosure.

FIG. 3 depicts a schematic view of an embodiment of a fenestration apparatus 100 configured as a secondary glazing system, where the fenestration apparatus 100 is positioned over an existing window 10 such that it sits within the enclosure 12 of the existing window 10 (within the window ledge/windowsill 14) and is configured to attach via an attachment member 132 comprising a plurality of compressive engagement members 138 with the existing window enclosure (e.g. windowsill 14).

FIG. 4A depicts a schematic view of an embodiment of a fenestration apparatus 100 configured as a secondary glazing system, where the fenestration apparatus 100 is positioned over an existing window 10 such that it sits adjacent to the enclosure of the existing window 10 (to thereby extend over/cover the existing window/glazing) and is configured to attach to the existing window frame 12 via at least one attachment member 132 configured as at least one mechanical attachment member 134, in accordance with one or more aspects of the present disclosure.

FIG. 4A depicts a schematic view of an embodiment of a fenestration apparatus 100 configured as a secondary glazing system, where the fenestration apparatus 100 is positioned over an existing window 10 such that it sits adjacent to the enclosure of the existing window 10 (to thereby extend over/cover the existing window/glazing) and is configured to attach to the existing window frame 12 via at least one attachment member 132 configured as at least one mechanical attachment member 134.

FIG. 4B depicts a schematic view of an embodiment of a fenestration apparatus 100 configured as a secondary glazing system, where the fenestration apparatus is positioned over an existing window 10 and existing frame 12 such that it sits adjacent to the enclosure of the existing window 10 (to thereby extend over/cover the existing window/glazing and the existing frame) and is configured to attach to the area adjacent to the existing window frame 16 (e.g. wall surface) via at least one attachment member 132 configured as at least one mechanical attachment member 134, in accordance with one or more aspects of the present disclosure.

FIG. 4B depicts a schematic view of an embodiment of a fenestration apparatus 100 configured as a secondary glazing system, where the fenestration apparatus 100 is positioned over an existing window 10 and existing frame 12 such that it sits adjacent to the enclosure of the existing window 12 (to thereby extend over/cover the existing window/glazing and the existing frame 12) and is configured to attach to the area adjacent to the existing window frame 16 (e.g. wall surface) via at least one attachment member 132 configured as at least one mechanical attachment member 134.

As shown in FIG. 3, FIG. 4A and FIG. 4B, with the cooperation of the existing fenestration assembly and the fenestration apparatus 100, an interior gap is defined. The gap 18 is configured to provide improved thermal properties, acoustic dampening, among other attributes.

Additionally, the surface of the laminate 110 or 120 facing the interior of the building is configurable with one or more coatings to provide enhanced user experience (e.g. ease in cleaning, anti-reflective coatings, warm touch, among others). Similarly, in instances where the existing fenestration assembly (existing window) 10 is an architectural feature (e.g. stained-glass window, leaded glass, or other aesthetically pleasing architectural features), the fenestration apparatus preserves the architectural aspects while providing improved performance (e.g. acoustics, energy) and a smooth interior/user facing surface (e.g. protecting aesthetic feature(s) from strikes or damage from users inside the building and/or providing a smooth/improved cleaning surface).

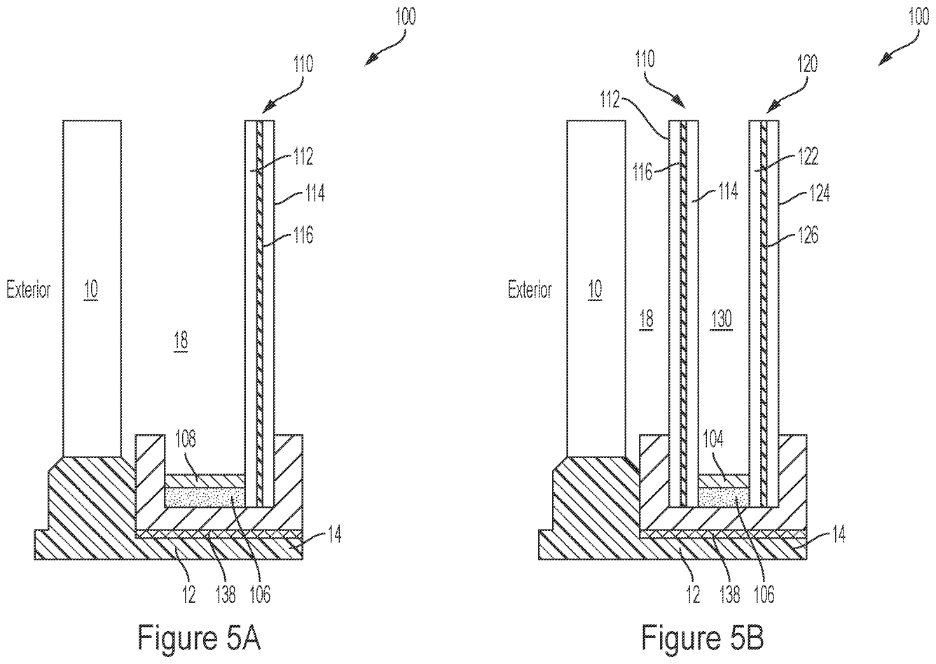

FIG. 5A depicts a schematic view of an embodiment of a fenestration apparatus 100 configured as a secondary glazing system, where the fenestration apparatus 100 having a laminate 110 retained in a frame 102, which is positioned over an existing window 10 such that it sits within the enclosure/windowsill 14 of the existing window 10 (e.g. within the window frame/window ledge) and is configured to attach via an attachment member 132 comprising a plurality of compressive engagement members 138 with the existing window frame/sill 12/14, in accordance with one or more aspects of the present disclosure.

FIG. 5B depicts a schematic view of an embodiment of a fenestration apparatus 100 configured as a secondary glazing system, where the fenestration apparatus 100 having a first laminate 110 and a second laminate 120 retained in a frame 102 with a spacer 104 configured between the first laminate 110 and second laminates 120, where the secondary glazing system is positioned over an existing window such that it sits within the enclosure of the existing window 10 (within the window ledge/window sill 14) and is configured to attach via an attachment member 132 comprising a plurality of compressive engagement members 138 with the existing window enclosure frame 12/windowsill 14, in accordance with one or more aspects of the present disclosure.

FIG. 5A and FIG. 5B illustrate two embodiments positioned in accordance with that depicted in FIG. 3, with the attachment member 132 on the frame 102 configured as at least one compression member 138 to retain the fenestration apparatus 100 in a removably attached position on the existing window 10/window frame 12, within the windowsill 14.

FIG. 5A depicts a single laminate 110, while FIG. 5B depicts two laminates, a first laminate 110 and a second laminate 120. As shown, FIG. 5A is configured with a single defined gap 18 between the existing window 10 and the first laminate 110, while FIG. 5B is configured with two defined gaps, a first defined gap 18 and a second defined gap 128 between the first laminate 110 and the second laminate 120. Since the gap 128 is configured with sealing engagement between two laminates, the seal (seal 106 and spacer 104) and frame 102, the gap 128 is configurable with a gas (e.g. insulating gas) sealed therein (e.g. to provide thermal insulation properties/improved thermal performance).

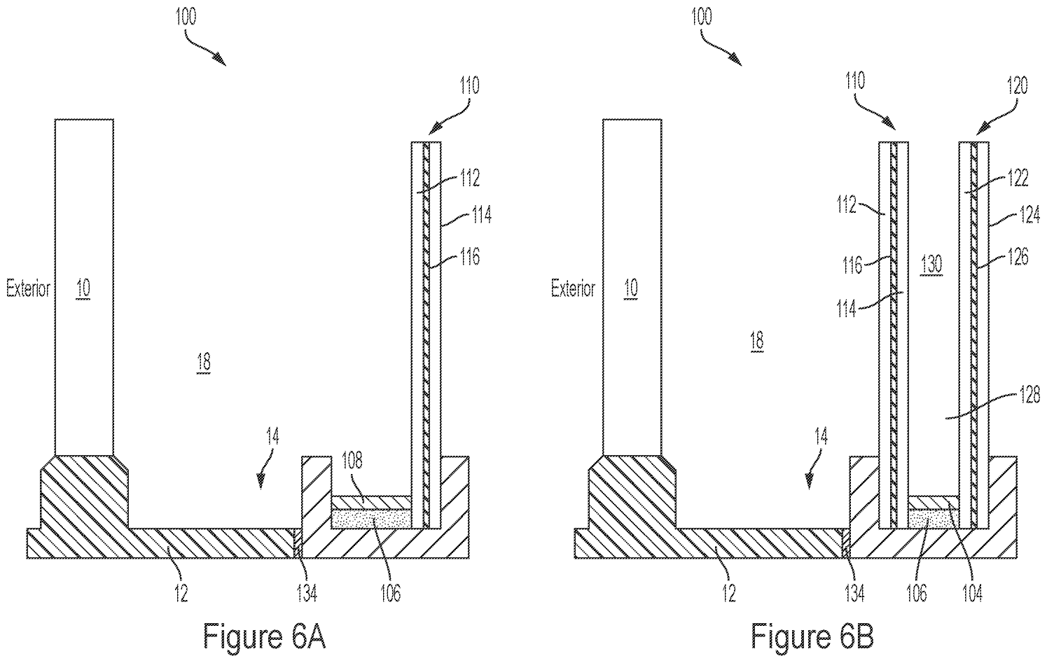

FIG. 6A depicts a schematic view of an embodiment of a fenestration apparatus 100 configured as a secondary glazing system, where the fenestration apparatus 100 having a laminate 110 retained in a frame 102, which is positioned over an existing window 10 such that it sits adjacent to the existing frame 12 and is configured to attach via an attachment member 132 comprising a mechanical attachment member 134 to the existing frame 12, in accordance with one or more aspects of the present disclosure.

FIG. 6B depicts a schematic view of an embodiment of a fenestration apparatus 100 configured as a secondary glazing system, where the fenestration apparatus 100 having a first laminate 110 and a second laminate 112 retained in a frame 102 with a spacer 104 configured between the first laminate 110 and second laminates 120, where the fenestration apparatus is positioned over an existing window 10 such that it sits adjacent to the existing frame 12 and is configured to attach via an attachment member 132 comprising a mechanical attachment member 134 to the existing frame 12, in accordance with one or more aspects of the present disclosure.

FIG. 6A and FIG. 6B illustrate two embodiments positioned in accordance with that depicted in FIG. 4A and FIG. 4B, with the attachment member 132 on the frame 102 configured as at least one mechanical attachment member 134 to retain the fenestration apparatus 100 in a removably attached position on the existing frame 12.

FIG. 6A depicts a single laminate 110, while FIG. 6B depicts two laminates, a first laminate 110 and a second laminate 120. As shown, FIG. 6A is configured with a single defined gap 18 between the existing window 10 and the first laminate 110, while FIG. 6B is configured with two defined gaps, a first defined gap 18 and a second defined gap 128 between the first laminate 110 and the second laminate 120. Since the gap 128 is configured with sealing engagement between two laminates, the seal (seal 106 and spacer 104) and frame 102, the gap 128 is configurable a gas sealed therein (e.g. to provide thermal insulation properties/improved thermal performance).

FIG. 7A and FIG. 7B depict schematic views of an embodiment of a fenestration apparatus 100 configured as a secondary glazing system, in accordance with one or more aspects of the present disclosure.

Referring to FIG. 7A, the fenestration apparatus 100 having a laminate 110 retained in a frame 102, which is configured to extend across an existing window 10, where the frame 102 is configured to both (a) rest within an existing frame 12 on the windowsill 14 and be retained (e.g. removably attached) via an attachment member 132 that comprises a compression member 138; and (b) extend adjacent to the existing frame 12 via a frame extension 140, such that the frame extension 140 is configured to mechanically attach to the existing frame 12 (or area adjacent to the existing fenestration assembly 16) via a mechanical attachment member 136.

FIG. 7B depicts a schematic view of an embodiment of a fenestration apparatus 100 configured as a secondary glazing system, where the fenestration apparatus 100 having a first laminate 110 and a second laminate 120 retained in a frame (and with a spacer 104 configured between the first laminate 110 and the second laminate 120), where the fenestration apparatus is configured to extend across an existing window 10, where the frame 102 is configured to both (a) rest within an existing frame 12 and be retained via an attachment member 132 that comprises a compression member 138; and (b) extend adjacent to the existing frame 12, such that the frame 102 extension is configured to mechanically attach to the existing frame 12, in accordance with one or more aspects of the present disclosure.

FIG. 7A depicts a single laminate 110, while FIG. 7B depicts two laminates, a first laminate 110 and a second laminate 120. As shown, FIG. 7A is configured with a single defined gap 18 between the existing window 10 and the first laminate 110, while FIG. 7B is configured with two defined gaps, a first defined gap 18 and a second defined gap 128 between the first laminate 110 and the second laminate 120. Since the gap 128 is configured with sealing engagement between two laminates, the seal (seal 106 and spacer 104) and frame 102, the gap 128 is configurable a gas sealed therein (e.g. to provide thermal insulation properties/improved thermal performance).

It is noted that the extension portion 140 of the frame 102 is also configurable to extend beyond the existing frame 102, such that the fenestration apparatus 100 is configured to (a) rest within an existing frame 12 on the windowsill 14 and be retained via an attachment member 132 that comprises a compression member 138; and (b) extend adjacent to the existing fenestration assembly area 16 surrounding the existing frame 12 (e.g. wall), such that the frame extension 140 is configured to mechanically attach via a mechanical attachment member 134 to the area surrounding the existing fenestration assembly 16, in accordance with one or more aspects of the present disclosure.

It is noted that the extension portion of the frame 102 is also configurable to extend beyond the existing frame 12, such that the fenestration apparatus is configured to (a) rest within an existing frame 12 and be retained via an attachment member 132 that comprises a compression member 138; and (b) extend adjacent to the existing fenestration assembly area 16 surrounding the existing frame 12 (e.g. wall), such that the frame extension 140 is configured to mechanically attach via a mechanical attachment member 134 to the fenestration assembly area 16 surrounding the existing frame 12, in accordance with one or more aspects of the present disclosure.

### Example: Modeling of Fenestration Apparatus Embodiments vs. Comparative Examples

Computer modeling was completed to evaluate the difference in acoustic performance for various fenestration assemblies disclosed herein, as compared to comparative examples. Commercially available WINDOW and INSUL software was utilized to model several configurations of fenestration assemblies, with comparative results (e.g. total thickness; Sound Transmission Class, as measured in accordance with ASTM E413, and sound reduction, as measured in accordance with ASTM E1332 (Outdoor Indoor Transmission Class) set forth herein in the table below.

| | | | Design 1 | Design 2 |
|---|---|---|---|---|
| | Compar- | Compar- | single | double |
| | ative Ex. 1 | ative | laminate | laminate |
| Construction | Single pane | Ex. 2 | (retrofit) | (retrofit) |
| Existing | 3 mm | 3 mm | 3 mm | 3 mm |
| window | | | | |
| Gas Cavity | | 16 mm air | 16 mm air | 16 mm air |
| Center Pane | | | 0.5 mm | 0.5 mm |
| | | 3 mm | 1.14 mm PVB | 1.14 mm PVB |
| | | | 0.5 mm | 0.5 mm |
| Gas Cavity | | | | 10 mm Argon |
| Inner Pane | | | | 0.5 mm |
| | | | | 1.14 mm PVB |
| | | | | 0.5 mm |
| Weight | 7.5 | 15 | 10.8 | 14.1 |
| (kg/m²) | | | | |
| U_{g} | 5.417 | 2.633 | 2.616 | 1.594 |
| (W/m²/K) | | | | |
| SHGC | 0.859 | 0.762 | 0.771 | 0.705 |
| STC (dB) | 28 | 29 | 30 | 34 |
| OITC (dB) | 22 | 24 | 25 | 28 |

Comparative Example 1 provides an existing single pane window having 3 mm of soda lime glass. Comparative Example 2 provides a double insulated glazing unit, having two thick soda lime glass sheets separated by a gap of air in between. Design 1 provides a fenestration apparatus having a single laminate comprising 2 thin glass sheets and a polymer interlayer, as described in the present disclosure. This is also referred to as a double IGU (i.e. when functioning in place, over a 3 mm thick piece of soda lime glass/the existing fenestration assembly). Design 2 provides a fenestration apparatus having two laminates, where each laminate is configured of thin glass (e.g. <1 mm thick borosilicate glass) with a polymer interlayer positioned therebetween, configured in spaced relation via a spacer and secondary seal, as described in the present disclosure. This is also referred to as a triple IGU (i.e. when functioning in place, over a 3 mm thick piece of soda lime glass/the existing fenestration assembly).

The table depicts the parameters of various retrofit windows and shows the modeling results of various parameters, including weight, thermal performance, and acoustic properties for several window configurations. The reported values are for the center of glass (COG) performance; the full window values will depend on the window size and installation details such as framing.

Comparative Example 1, the existing single-pane window, has a high Ug-value, which represents high heat loss and is undesirable in cold climates/seasons. It also has a high solar heat gain coefficient (SHGC), which is undesirable in warm climates/seasons.

In contrast, Comparative Example 2, the thick double IGU, has considerably lower Ug and SHGC. It also reduces sound transmission through the window, as indicated by its higher STC and OITC values. However, the weight of the glass is double that of Comparative Example 1, making the SGS difficult to handle and install. In many historic buildings the existing framework may not be capable of handling the additional glass weight.

Design 1, using a thin glass laminate, also offers lower Ug and SHGC than Comparative Example 1. Design 1 is able to match the improved thermal properties of Comparative Example 2 at a weight closer to that of Comparative Example 1. Furthermore, the acoustic performance of Design 1, as measured by STC and OITC, is better than the considerably heavier Comparative Example 2. Addition of a second thin glass laminate, as in Design 2, further improves the thermal and acoustic properties at a weight less than that of Comparative Example 2.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. As a non-limiting example, about means less than 10% of the referenced value.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

Many variations and modifications may be made to the above-described embodiments of the disclosure without departing substantially from the spirit and various principles of the disclosure. All such modifications and variations are intended to be included herein within the scope of this disclosure and protected by the following claims.

1. A fenestration apparatus, comprising:
at least one glass pane comprising a laminate, wherein the laminate has a thickness of not greater than 3 mm, wherein the laminate comprises a first glass layer a second glass layer, and an interlayer configured between the first glass layer and the second glass layer to attach the first glass layer to the second glass layer;
a frame, configured perimetrically around a corresponding perimetrical edge of the glass pane;
a seal, configured between the frame and the glass pane; and
an attachment member configured to the frame, wherein the attachment member is configured to be removably fixable to an existing window wherein the attachment member is configured to define a gap between the frame, the at least one glass pane, and the existing window.

2. The apparatus of claim 1, wherein the attachment member comprises a compression member.

3. The apparatus of claim 1, wherein the attachment member comprises an expandable gasket and a release member.

4. The apparatus of claim 1, wherein the attachment member comprises a mechanical attachment member, wherein the mechanical attachment member is configured to cooperate in mating engagement with a corresponding fenestration assembly.

5. The apparatus of claim 1, wherein the frame is configured with a base, configured to retain on an existing window frame and/or alongside an existing window frame assembly.

6. The apparatus of claim 1, wherein the frame is configured with at least two upward extensions along the perimetrical edge of the glass laminate, such that the first extension is configured alongside the first glass layer and the second extension is configured alongside the second glass layer.

7. The apparatus of claim 1, wherein the existing window comprises an adjacent perimetrical ledge/extension.

8. The apparatus of claim 1, wherein the first glass layer is not greater than 1 mm thick.

9. The apparatus of claim 1, wherein the second glass layer is not greater than 1 mm thick.

10. The apparatus of claim 1, wherein the interlayer comprises a thickness of not greater than 2.5 mm.

11. The apparatus of claim 1, wherein the interlayer comprises a polymer.

12. The apparatus of claim 1, wherein the interlayer comprises: a polymer, a polyester, a polyurethane, an ionomer, and/or combinations thereof.

13. The apparatus of claim 1, wherein the interlayer comprises: a polyvinyl butyral (PVB), a thermoplastic polyurethane (TPU), a PET, and combinations thereof.

14. The apparatus of claim 1, wherein the laminate comprises a coating on at least one of:
a. a first major surface of the first glass layer,
b. a second major surface of the second glass layer, and
c. both the first major surface of the first glass layer and the second major surface of the second glass layer.

15. The apparatus of claim 1, wherein the interlayer is an acoustic dampening polymer configured for noise reduction.

16. The apparatus of claim 1, wherein the fenestration apparatus is a removable secondary glazing assembly.

17. The apparatus of claim 1, wherein the interlayer is a tinted polymer configured for light absorption.

18. The apparatus of claim 1, wherein the fenestration apparatus passes a safety test as set out in ANSI Z97.1 or EN 12600 standard, when measured in accordance with the standard.

19. The apparatus of claim 1, wherein at least one of the first glass layer and the second glass layer is a chemically strengthened glass.

20. The apparatus of claim 1, further comprising a second pane is disposed in spaced relation from the first pane.

21.-36. (canceled)
